(19) United States
(12) Patent Application Publication
(10) Pub. No.: US 2017/0151119 A1
(43) Pub. Date: Jun. 1, 2017

(54) POWER-DRIVEN TRACTION DEVICE FOR NECK PHYSICAL THERAPY

(71) Applicant: FENG CHING TU, TAIPEI CITY (TW)

(72) Inventor: FENG CHING TU, TAIPEI CITY (TW)

(21) Appl. No.: 15/275,936

(22) Filed: Sep. 26, 2016

(30) Foreign Application Priority Data
Dec. 1, 2015 (TW) 104219259

(51) Int. Cl. A61H 1/02

(52) U.S. Cl. CPC A61H 1/0296

(57) ABSTRACT

A power-driven traction device for neck physical therapy includes a rail platform disposed on a base and a traction mechanism used for drawing a user's neck disposed on the platform. The traction mechanism includes a neck rest portion and a drive portion. The neck rest portion is coupled with the drive portion. The drive portion is slidably disposed on the rail platform and connected with a power-driven drive device. The power-driven drive device is connected with the drive portion to bring the neck rest portion to slide backward and forward on the rail platform in a longitudinal direction. It is convenient for the user to operate the power-driven traction device by himself. The force to draw the user's neck can be controlled finely and well.

### FIELD OF THE INVENTION

The present invention relates to a traction device for neck physical therapy, and more particularly to a neck traction device with a power-driven drive device to control the operation of the traction device precisely.

### BACKGROUND OF THE INVENTION

A traction machine is often used to perform physical therapy for the cervical vertebra, the rachis or the lumbar vertebra, enabling the muscles in the neck or the waist to stretch or the cervical vertebra or the rachis to straighten, achieving the effect of pain relief or therapeutic restoration. As shown in FIG. 1, a conventional traction machine used for the cervical vertebral physical therapy comprises a traction seat 91. One end of the traction seat 91 is provided with a neck seat 92 and a head rest portion 93. Another end of the traction seat 91 is provided with a push portion 94. The push portion 94 can link the neck seat 92 and the head rest portion 93. A pneumatic cylinder 95 is provided beneath the traction seat 91. The pneumatic cylinder 95 leans against the push portion 94. The outer side of the neck seat 92 is provided with a lie-down cushion 96. When in use, the user lies down on the lie-down cushion 96. The neck is positioned and clamped on the neck seat 92. The head is rested on the head rest portion 93. The user operates a push device (not shown in the drawings) to link and control the actuation of the pneumatic cylinder 95 through an air pipe 951. The pneumatic cylinder 95 is actuated to push the push portion 94 and further to link the neck seat 92 and the head rest portion 93 to displace, achieving a neck traction effect.

Although the conventional traction machine is able to provide a traction effect, it still has some shortcomings. For example, the user operates the push device to control the actuation of the pneumatic cylinder 95. The push device is like a pump, namely, the push device is pushed back and forth by the user for pumping air in. It is quite inconvenient for the user to operate traction. Besides, it is difficult to control the force applied to the machine. Accordingly, the inventor of the present invention has devoted himself based on his many years of practical experiences to solve these problems.

### SUMMARY OF THE INVENTION

The primary object of the present invention is to provide a power-driven traction device for neck physical therapy. It is convenient for the user to operate the power-driven traction device by himself. The force to draw the user's neck can be controlled finely and well.

In order to achieve the aforesaid object, the power-driven traction device for neck physical therapy of the present invention comprises a base, a rail platform, a traction mechanism used for drawing a user's neck, and a power-driven drive device. The rail platform is disposed on the base. The traction mechanism includes a neck rest portion and a drive portion. The neck rest portion is coupled with the drive portion. The drive portion is slidably disposed on the rail platform. The power-driven drive device is connected with the drive portion. The drive portion is driven by the power-driven drive device to slide backward and forward on the rail platform in a longitudinal direction.

Wherein, the rail platform is provided with a pair of rails extending in the longitudinal direction. The drive portion has a pair of rail grooves corresponding to the pair of rails. The drive portion is slidably disposed on the rail platform through the pair of rail grooves.

Furthermore, the rail platform is provided with a first retaining member. The drive portion is provided with a second retaining member. The second retaining member has a through threaded hole. The first retaining member is pivotally provided with a screw rod extending in the longitudinal direction. The screw rod is inserted through the threaded hole of the second retaining member and connected to the power-driven drive device.

In an embodiment, the power-driven drive device is a stepper motor.

In an embodiment, the rail platform is inclined at an angle relative to a horizontal plane and disposed on the base, and the angle is adjustable.

In an embodiment, the neck rest portion is provided with two neck clamping blocks for clamping the user's neck, and each neck clamping block is provided with a heating unit.

In an embodiment, the power-driven drive device is electrically connected with a control device, and the power-driven drive device is controlled by the control device.

In an embodiment, the base is provided with a back rest portion located in front of the neck rest portion, and the back rest portion is provided with a heating unit.

### BRIEF DESCRIPTION OF THE DRAWINGS

FIG. 1 is a schematic view of a conventional traction device;

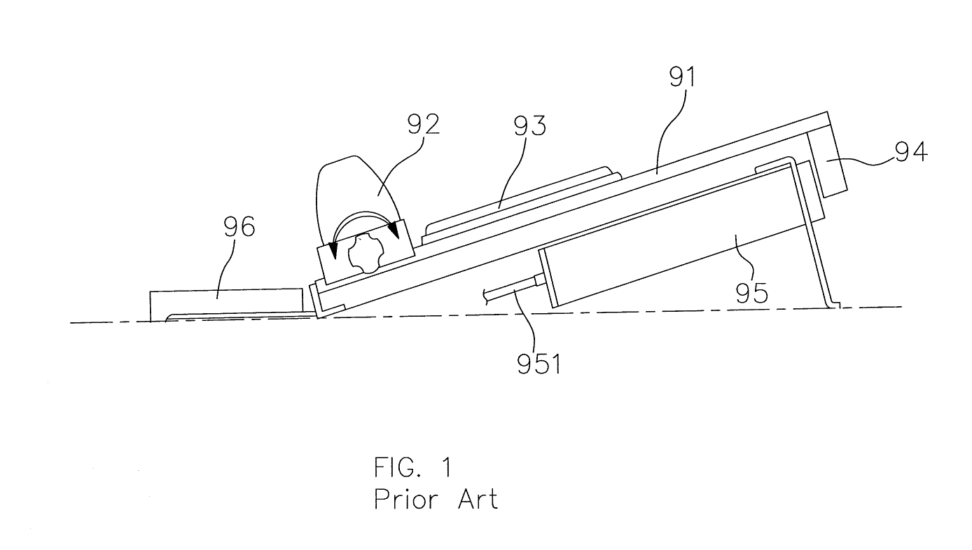

FIG. 2 is a perspective view of the present invention;

FIG. 3 is an exploded view of the present invention;

FIG. 4 is a sectional view taken along line A-A of FIG. 2;

FIG. 5 is a sectional view taken along line B-B of FIG. 4; and

FIG. 6 is a schematic view of the present invention when in use.

### DESCRIPTION OF THE PREFERRED EMBODIMENTS

Embodiments of the present invention will now be described, by way of example only, with reference to the accompanying drawings.

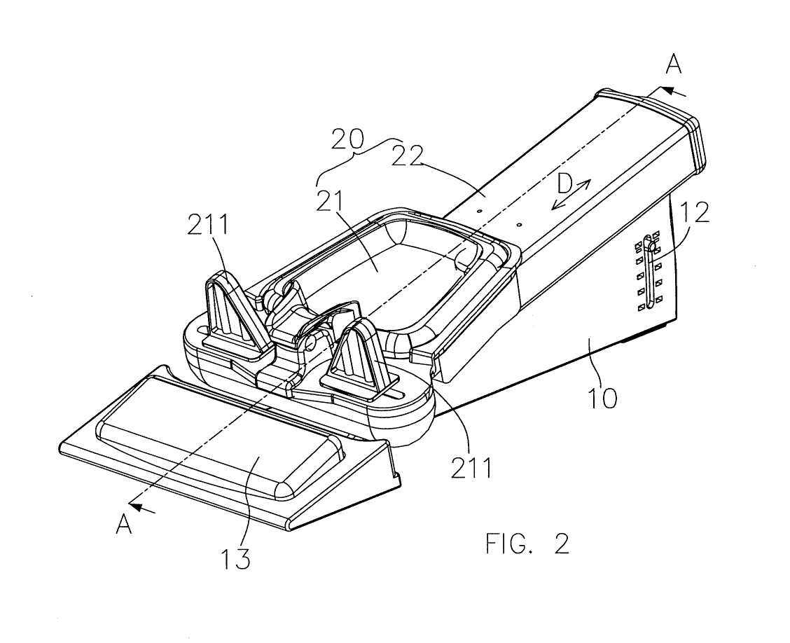

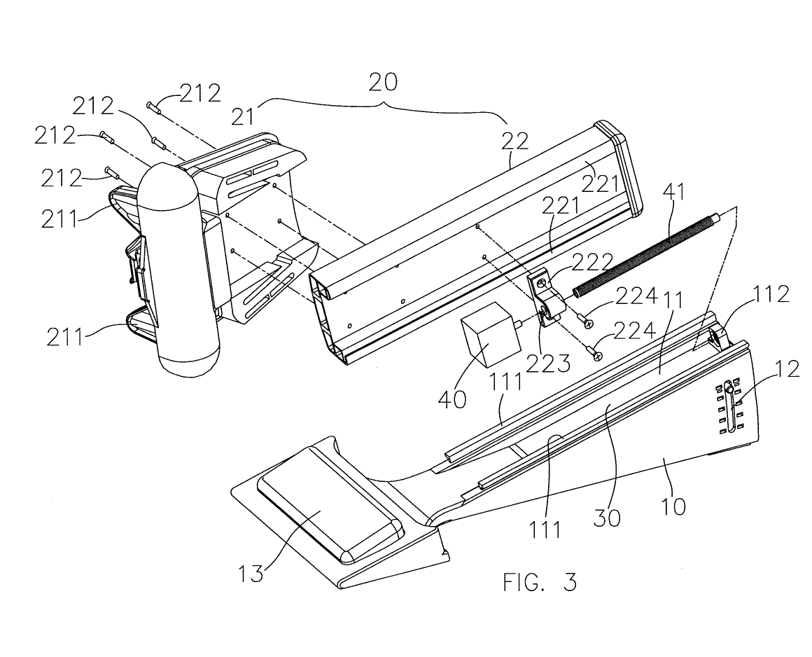

Referring to FIG. 2 and FIG. 3, the present invention discloses a power-driven traction device for neck physical therapy. The power-driven traction device comprises a base 10 defined in a stationary state. The base 10 extends in a longitudinal direction D1. One end of the base 10 is higher than another end of the base 10, so the base 10 has a slope. The base 10 is provided with a rail platform 11 thereon. Because of the slope of the base 10, the rail platform 11 is inclined at an angle relative to a horizontal plane and disposed on the base 10. In this embodiment, the rail platform 11 is provided with an adjustment mechanism 12 at the higher end of the base 10. The adjustment mechanism 12 can adjust the height of the rail platform 11 relative to the base 10, so that the inclined angle of the rail platform 11 can be adjusted according to the demand of use.

The rail platform 11 is provided with a traction mechanism 20 for drawing the user's neck. The traction mechanism 20 includes a neck rest portion 21 and a drive portion 22. The neck rest portion 21 is disposed at the lower end of the rail platform 11 and provided with two neck clamping blocks 211 for clamping the user's neck. The two neck clamping blocks 211 are symmetrically disposed relative to the longitudinal direction D. The drive portion 22 extends toward the higher end of the rail platform 11, and is fixedly connected with the neck rest portion 21 by a plurality of screws 212. In this embodiment, the base 10 is provided with a back rest portion 13 located in front of the neck rest portion 21 for the user's back to rest thereon.

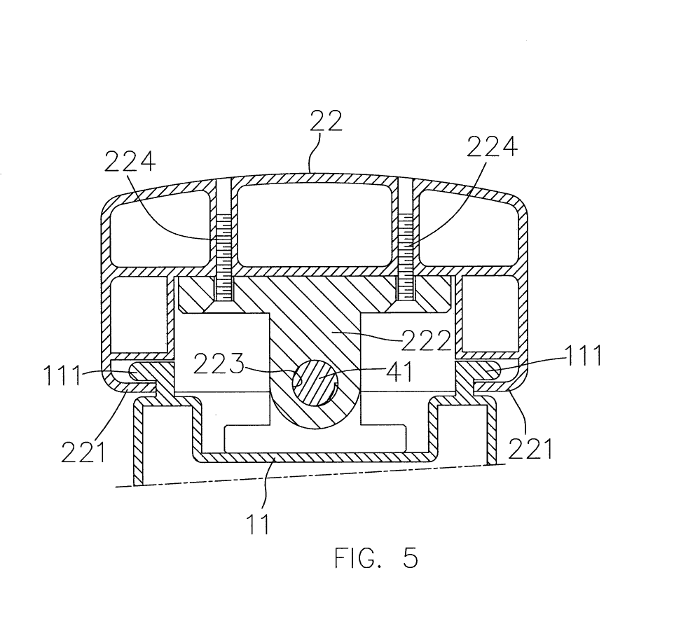

The rail platform 11 is provided with a pair of rails 111 extending in the longitudinal direction D. The drive portion 22 has a pair of rail grooves 221 corresponding to the pair of rails 111. The drive portion 22, as shown in FIG. 5, is assembled to the rail platform 11 through the pair of rail grooves 221 to mate with the pair of rails 111, such that the drive portion 22 with the neck rest portion 21 can slide along the pair of rails 111 relative to the rail platform 11.

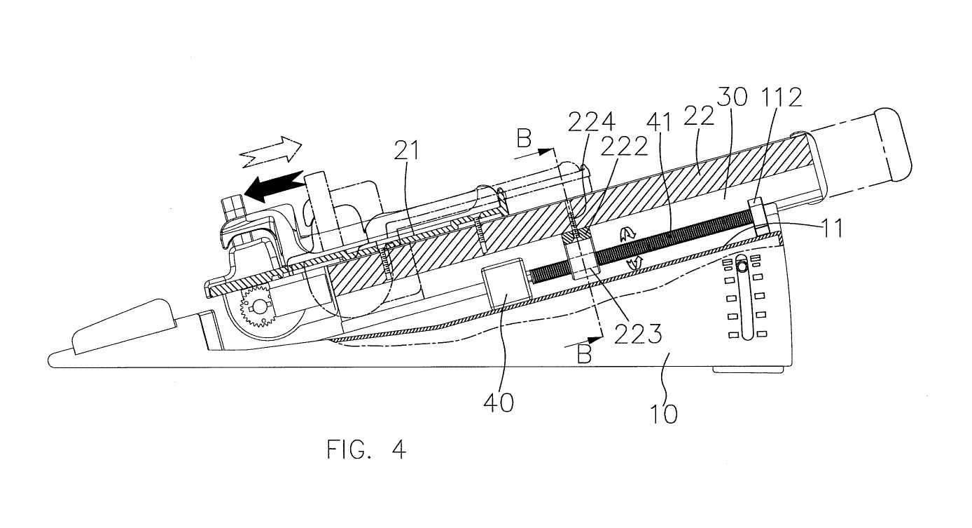

As shown in FIG. 3 and FIG. 4, an accommodation space 30 is formed between the drive portion 22 and the rail platform 11. In the accommodation space 30, the rail platform 11 is provided with a first retaining member 112, and the drive portion 22 is provided with a second retaining member 222. The second retaining member 222 has a through threaded hole 223. The second retaining member 222 is secured to the drive portion 22 with a plurality of screws 224. A screw rod 41 and a power-driven drive device 40 (in this embodiment, it is a stepper motor) are provided in the accommodation space 30. The screw rod 41 extends in the longitudinal direction D. One end of the screw rod 41 is pivotally connected to the first retaining member 112, and another end of the screw rod 41 is inserted through the threaded hole 223 of the second retaining member 222 and connected to the power-driven drive device 40.

As shown in FIG. 4, when the power-driven drive device 40 is actuated to drive the screw rod 41 to turn around, the second retaining member 222 is driven to move along the screw rod 41 because the screw rod 41 is pivotally connected to the first retaining member 112. That is to say, the second retaining member 222 is driven to displace in the longitudinal direction D. Furthermore, because the second retaining member 222 is connected with the drive portion 22 and the neck rest portion 21, the drive portion 22 and the neck rest portion 21 are synchronously moved along with the second retaining member 222 to bring a displacement in the longitudinal direction D for performing the traction action of neck physical therapy.

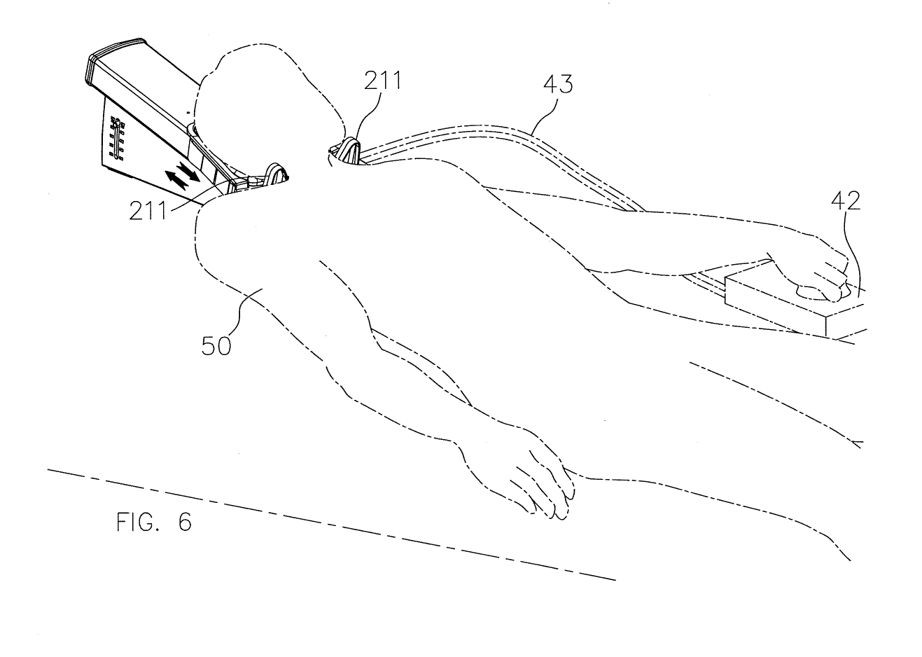

Besides, in this embodiment, the power-driven drive device 40 is electrically connected with a control device 42. The power-driven drive device 40 is controlled by the control device 42. As shown in FIG. 6, the control device 42 is disposed at a far position and electrically connected with the power-driven drive device (not shown in the drawings) through an electric wire 43. The user 50 lies down, and his/her neck is clamped between the two neck clamping blocks 211. The control device 42 is disposed at a position where the user 50 can operate it conveniently, such that the user 50 can operate the power-driven drive device conveniently by himself to control the two neck clamping blocks 211 to clamp the user's neck.

In this embodiment, the two neck clamping blocks 211 of the neck rest portion 21, used for claiming the user's neck, is each provided with a heating unit therein to warm and heat the user's neck for relaxing the muscles.

In this embodiment, the back rest portion 13 of the base 10, located in front of the neck rest portion, is provided with a heating unit therein to warm and heat the user's shoulder and back for relaxing the muscles.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A power-driven traction device for neck physical therapy, comprising:
a base;
a rail platform, disposed on the base;
a traction mechanism used for drawing a user's neck, the traction mechanism including a neck rest portion and a drive portion, the neck rest portion being coupled with the drive portion, the drive portion being slidably disposed on the rail platform; and
a power-driven drive device, connected with the drive portion, the drive portion being driven by the power-driven drive device to slide backward and forward on the rail platform in a longitudinal direction.

2. The power-driven traction device for neck physical therapy as claimed in claim 1, wherein the rail platform is provided with a pair of rails extending in the longitudinal direction, the drive portion has a pair of rail grooves corresponding to the pair of rails, and the drive portion is slidably disposed on the rail platform through the pair of rail grooves.

3. The power-driven traction device for neck physical therapy as claimed in claim 1, wherein the rail platform is inclined at an angle relative to a horizontal plane and disposed on the base, and the angle is adjustable.

4. The power-driven traction device for neck physical therapy as claimed in claim 1, wherein the rail platform is provided with a first retaining member; the drive portion is provided with a second retaining member, and the second retaining member has a through threaded hole; the first retaining member is pivotally provided with a screw rod extending in the longitudinal direction, and the screw rod is inserted through the threaded hole of the second retaining member and connected to the power-driven drive device.

5. The power-driven traction device for neck physical therapy as claimed in claim 1, wherein the neck rest portion is provided with two neck clamping blocks for clamping the user's neck.

6. The power-driven traction device for neck physical therapy as claimed in claim 1, wherein the power-driven drive device is electrically connected with a control device, and the power-driven drive device is controlled by the control device.

7. The power-driven traction device for neck physical therapy as claimed in claim 1, wherein the base is provided with a back rest portion located in front of the neck rest portion.

8. The power-driven traction device for neck physical therapy as claimed in claim 1, wherein the power-driven drive device is a stepper motor.

9. The power-driven traction device for neck physical therapy as claimed in claim 5, wherein each of the two neck clamping blocks is provided with a heating unit therein to warm and heat the user's neck.

10. The power-driven traction device for neck physical therapy as claimed in claim 7, wherein the back rest portion is provided with a heating unit therein to warm and heat the user's shoulder and back.
